(19) United States
(12) Patent Application Publication
(10) Pub. No.: US 2007/0092144 A1
(43) Pub. Date: Apr. 26, 2007

(54) Random data resampling for medical imaging

(76) Inventors: Chuanyong Bai, Poway, CA (US); Joel Kindem, San Diego, CA (US); Jeff Gordon, San Diego, CA (US); Richard L. Conwell, Del Mar, CA (US); Hetal Babla, Poway, CA (US)

Correspondence Address: FISH & RICHARDSON, PC, P.O. BOX 1022, MINNEAPOLIS, MN, 55440-1022, US

(21) Appl. No.: 11/506,607

(22) Filed: Aug. 17, 2006

Related U.S. Application Data
(60) Provisional application No. 60/709,158, filed on Aug. 17, 2005.

(51) Int. Cl. G06K 9/36; G06K 9/00

(52) U.S. Cl. 382/232; 382/128

(57) ABSTRACT

Medical imaging information is randomly resampled into the new resampled form. The random resampling can maintain the random nature of the information, and can avoid count loss.

### CROSS-REFERENCE TO RELATED APPLICATIONS

This application claims priority to U.S. application Ser. No. 60/709,158, filed on Aug. 17, 2005. The disclosure of the prior application is considered part of (and is incorporated by reference in) the disclosure of this application.

### BACKGROUND

Data from medical imaging has conventionally been stored prior to processing. The data is often stored in short integer format. The short integer format has been chosen rather than a floating format for two major reasons. A first is to reduce the size of the data, in order to conserve the computer storage space and transfer time. A second reason, however, is that many existing formats, such as Dicom and Interfile use the short integer format for data transfer and sharing.

Medical imaging data may need to be resampled and then resaved in short integer format. This may be done for purposes such as data resampling from a small matrix to a large matrix and/or data resampling for purposes such as interpolation, smoothing, correction (e.g. motion correction, center of rotation correction), and others.

### SUMMARY

Resampling overall medical imaging data in short integer format may introduce data truncation errors which lead to data loss. In low signal level features, such as medical imaging, the truncation errors may add to the noise in the system.

According to an aspect, a special technique is used to resample data that has low counts, in a way that avoids or minimizes data loss.

### BRIEF DESCRIPTION OF THE DRAWINGS

FIG. 1 is an illustration showing a camera with a processing computer;

FIGS. 2a and 2b are charts showing a pixel replication technique;

FIG. 3 is a chart showing bilinear interpolation technique;

FIGS. 4 and 5 are charts showing random data resampling using weights;

FIG. 6 is a chart showing random resampling using weights as used for bilinear interpolation; and

FIG. 7 is a chart showing the combination of the conventional and random resampling techniques.

### DETAILED DESCRIPTION

The general structure and techniques, and more specific embodiments which can be used to affect different ways of carrying out the more general goals, are described herein.

A conventional technique of resampling saved data will be described using image interpolation as an example. Assume that there are two neighboring pixels in the image, with values P1 and P2 respectively. These are to be interpolated so that each pixel will have a pixel value that is an average of the two, for example, (p1+p2)/2. When the interpolation is done in floating-point and saved in floating-point, no data is lost. But when the data is saved in short imager, data truncation can occur. The truncation may be negligible when the pixel value is high, e.g. when P1+P2 is much greater than 1 in the raw data. In many medical imaging applications, the pixel value is relatively low. In this case, the inventors found that the truncation can introduce potentially severe data loss.

Consider an example where P1 has a value of one and P2 has a value of two. In float, the average of P1 and P2 is 1.5. Therefore, the interpolated value saved in float would have a value of 1.5, and a total of three. The values, as well as their normal or sum is preserved over the whole set of information.

If the interpolated data is to be saved in short integer form, in contrast, than 1.5 is truncated to 1, each pixel gets a value of 1, and the total is 2. The norm of the data becomes 50% less than the original. Putting this another way, 50% of the data is lost due to the interpolation and saving the interpolated data in short integer. When the pixel value is high, for example P1+P2=101, the data loss would be 1/101 or approximately 1%.

More realistic values, in a gated rest cardiac SPECT study, the maximum pixel value of projection data of a gated frame is less than 10. Conventional resampling techniques may introduce data loss of over 20%.

Data resampling due to motion correction or center of rotation correction based on a conventional interpolation techniques e.g. linear interpolation, bilinear interpolation and others may also introduce severe data loss. For example, motion correction that is performed every 50 ms during SPECT data acquisition produces extremely low counts. For low counts, the conventional techniques lead to large data loss.

A first technique to reduce the data loss is a scaling technique. The raw data can be scaled by a factor before the resampling. For example, using the example above with P1=1 and P2=2, and scale the data up by a factor of 10 before resampling. With P1 equals 10 and P2 equals 20, the interpolation results in 15 for both of the pixels, the total becomes 30 with no data loss. While this technique will reduce the data loss, the scaling factor needs to be saved and carried along with the data, making the data handling more complicated. Especially for a dynamic range of a short integer system, this may limit the value of the scaling factor that can be used.

Another technique stores each acquired event separately to form list mode data. Data corrections are applied to each event separately to avoid data loss. This technique requires a larger storage space, and more complicated dated handling.

An embodiment describes using a Monte Carlo technique to resample medical imaging data that has low counts/pixel value to reduce data loss. The incoming counts are simulated in a weighted random matter, and handled based on their values. This may model the statistical nature of the data better than conventional techniques.

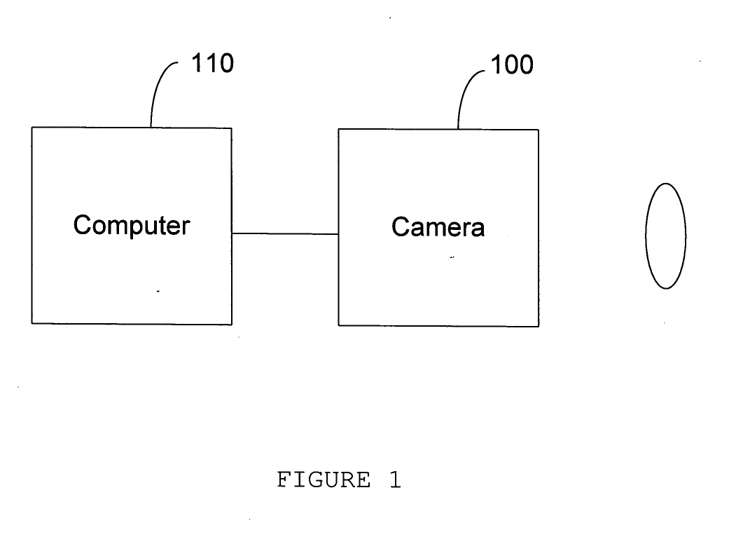

FIG. 1 illustrates a cardiac SPECT imaging camera 100, with a processing computer 110 that processes the data obtained from the camera. For one of various purposes to be described herein, the data will be resampled. A resampling can be carried out or visualized as a matrix. Assuming that a small matrix is 64×64, and a large matrix is something larger e.g. 128×128, than one pixel in the small matrix corresponds to four pixels in the large matrix. A pixel in the small matrix with value P1 gets divided by 4, to a value P1/4 and assigned to four corresponding pixels in the large matrix. If the value P1/4 is saved in short integer, it can be truncated and thus lose data. As long as P1 is evenly divisible by 4, there is no data loss.

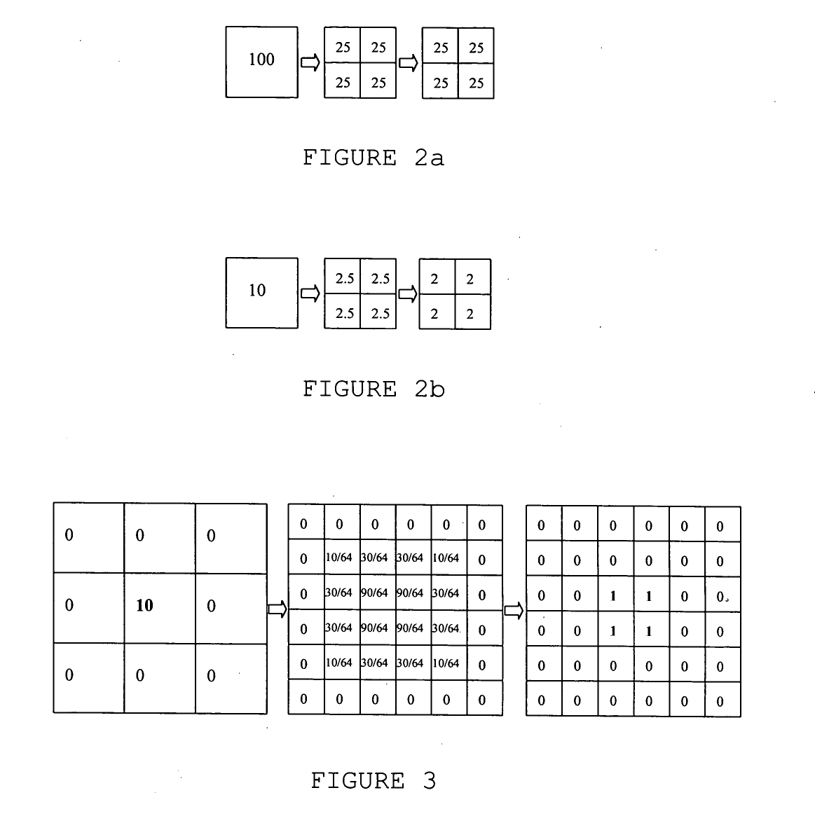

For example, FIG. 2a shows pixel replication for a value of 100, with no data loss. FIG. 2b shows the replication with a value P1. This produces a 20% data loss.

FIG. 3 illustrates the bilinear interpolation techniques. The neighboring four pixels in the smaller matrix are used to obtain the pixel value of the larger matrix. Different weights in different neighbor pixels are used in the larger pixel matrix. The effective weights effectively form a convolution kernel. The convolution of this kernel with the smaller matrix linearly interpolates the smaller matrix to the larger matrix. Note that the center pixels of the center matrix add up to 640/64=10, making the total value the same as the total value in the leftmost matrix. However, the rightmost matrix shows that when the data is saved as short integers, severe data loss may be introduced. The percentage data loss increases as the pixel value in the original matrix decreases.

FIG. 4 illustrates a flowchart of a weighted random resampling technique.

At 400, the system simulates that the counts in the small matrix hit the matrix one by one at different positions randomly at different weights and probabilities. Each weight is ostensibly based on the sole difference between the small and large matrices, plus or minus a scale factor. The simulation is done bilaterally and randomly, but ensures that the values add up to the original count value of P1.

At 410, the random position with its weight is used to determine where each of the random counts in the small matrix falls into the larger matrix.

At 420, the resampling process completes when all the events in the small matrix are processed by completing the previous steps.

If the weight is selected such that each count from a pixel in the small matrix falls into one of the four corresponding pixels in the larger matrix with equal probability, than the count to one of the four pixels in the larger matrix can be anything between 0 and P1. P1 in this case is the pixel value of the pixel in the small matrix. Statistically, the count to one of the four pixels in the larger matrix is likely to be something close to P1/4. When P1 is very large, the resampling converges to pixel replication.

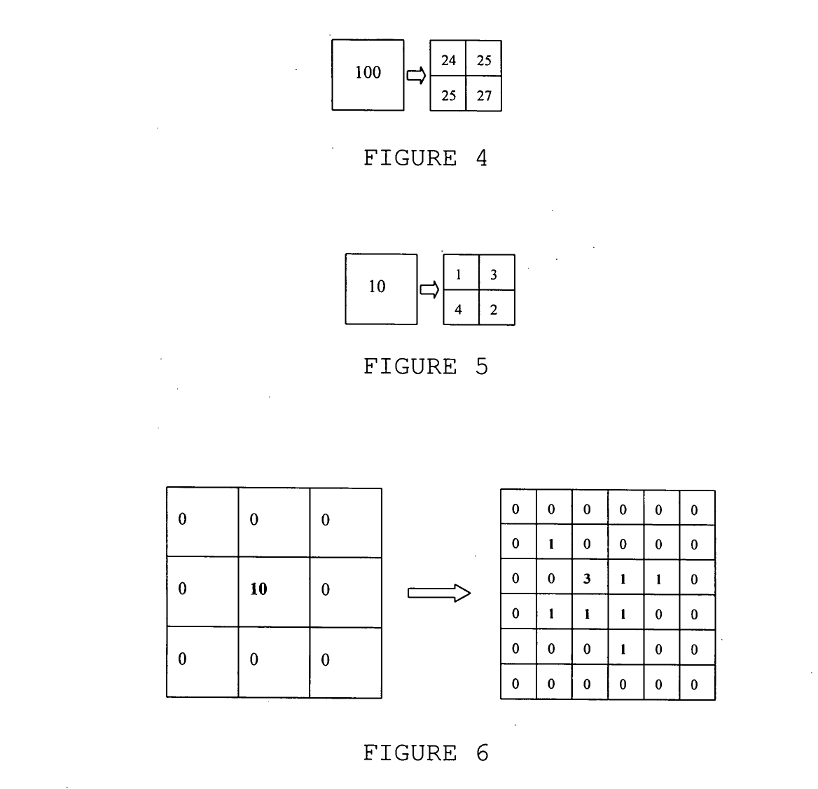

FIG. 5 illustrates how the system operates. With a P1 of 100, the values are bilaterally interpolated and randomly placed into different pixels in the rightmost array that is double the size of the original array. The random data resampling uses weights from each count from the pixel in the small matrix that has an equal probability to fall into each of the four corresponding pixels in the large matrix. Statistical randomness is hence maintained.

FIG. 6 illustrates the system used for bilinear interpolation. No count loss is experienced. When the count values become high, the results converge to those of the bilinear interpolation.

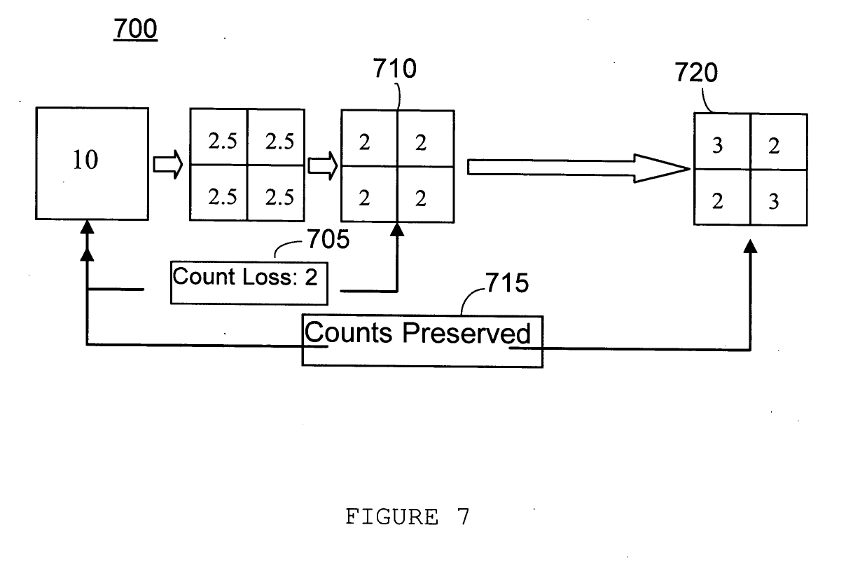

When the counts are high, the results from the random resampling converged to straight pixel replication, FIG. 7 may be used to combine the random resampling with the conventional pixel replication technique. FIG. 7 shows that a conventional pixel replication is used at 700, and count loss is determined at 705. The count loss matrix 710 has the lost counts added at 715 to produce a random resampling count 720.

Using the example described above, where P1 is equal to 10, the conventional pixel replication technique can be used for the first 8 counts, followed by using the random resampling technique with equal weights for the other 2 counts. This technique may also reduce computational time for a high count system.

The above has described using this system along with a gamma camera and medical imaging. However, this allows for effective resampling in any medical imaging study that has low pixel values or low counts, and resampling data that is saved in short integer format. This system preserves the data. Example applications include:
Resampling data from a small matrix to a large matrix
Resampling data from pixelated detectors to reduce the pixelization effect or mosaic effect
A resampling data for center of rotation correction especially when the center of rotation error is not an integer number of pixels
A resampling data for motion correction during acquisition e.g. on-the-fly motion correction
Scaling the image by a noninteger multiple of the original image size e.g. imaging zooming or scaling digitized energy spectra into energy space
Multidimensional scaling or effects of any of the types above
Real-time resampling.

The general structure and techniques, and more specific embodiments which can be used to effect different ways of carrying out the more general goals are described herein.

Although only a few embodiments have been disclosed in detail above, other embodiments are possible and the inventor (s) intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, this resampling may be used for other systems.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be a Pentium class computer, running Windows XP or Linux, or may be a Macintosh computer. The computer may also be a handheld computer, such as a PDA, cellphone, or laptop. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

What is claimed is:

1. A method, comprising:
obtaining original data indicative of counts forming elements of a medical image; and
randomly resampling the counts into another form, in a way that maintains the total number of counts, but forms new values for the counts as being randomly distributed in said other data form.

2. A method as in claim 1, wherein said randomly resampling comprises weighting the counts into a weighted form indicative of a difference between said original data and said other data form, and according to a random function.

3. A method as in claim 1, wherein said other data form is a matrix, which has more elements than a matrix representing said original data.

4. A method as in claim 3, wherein said random counts use weights and probabilities that are distributed bilaterally and randomly.

5. A method as in claim 1, further comprising determining if data loss will occur from a specified resampling;
using pixel replication if said determining determines that data loss will not occur; and
using said random resampling when said determining determines that data loss will occur.

6. A method as in claim 1, wherein said original data is indicative of counts of information from a gamma camera.

7. A method as in claim 3, wherein said data is placed in said matrix at locations and probabilities that are weighted according to a probability function.

8. A system, comprising:
an input from a medical imaging system which provides information indicative of counts that represent portions of an image; and
a random resampling device, that randomly resamples the counts to another form, but maintains an overall number of counts being the same.

9. A system as in claim 8, further comprising a gamma camera, connected to said input, and providing counts indicative of the medical imaging.

10. A system as in claim 8, wherein said random sampling device randomly resamples the counts into a matrix of a different form than an original form of the counts.

11. A system as in claim 8, wherein said random sampling device includes a data loss detection part that determines if data loss is likely to occur, and if data loss is not likely to occur then uses pixel replication, and if data loss is likely to occur, then uses weights and probabilities that are randomly distributed.

12. A system as in claim 8, wherein said random sampling device uses weights for each count from a pixel in the original data and weights the counts according to corresponding pixels within the resampled form.

13. A method, comprising:
obtaining data that is obtained from medical imaging that forms an image with pixels formed from counts from the medical imaging;
determining if an amount of obtained data is sufficient so the data is not likely to occur during resampling, and if so, replicating the pixels into a resampled form; and
if the data is not high enough so the data loss is not likely to occur during resampling, then randomly resampling the counts to a resampled form according to weights of corresponding pixels within the resampled form.
